(19) United States
(12) Patent Application Publication
(10) Pub. No.: US 2002/0064038 A1
(43) Pub. Date: May 30, 2002

(54) Surgical lamp assembly for mounting on a ceiling

(76) Inventor: Ryszard Kummerfeld, Lubeck-Travemunde (DE)

Correspondence Address: Walter Ottesen, Patent Attorney, P.O. Box 4026, Gaithersburg, MD, 20885-4026, US

(21) Appl. No.: 09/991,699

(22) Filed: Nov. 26, 2001

(30) Foreign Application Priority Data
Nov. 25, 2000 (DE) 100 58 721.6

(51) Int. Cl. F21V 33/00

(52) U.S. Cl. 362/33; 362/804

(57) ABSTRACT

A surgical lamp is mounted on a ceiling arm system (2) and is so improved that the entire light field can be uniformly aerated with germ-free air. The ceiling arm system (2) has a flow channel (12) which establishes a flow connection between the gas delivery unit (8) and the interior space (13) of the lamp. The light exit surface of the surgical lamp (1) is configured as a light permeable air-conducting plate (15) which has gas outlet openings (16) arranged in the manner of a mesh.

### BACKGROUND OF THE INVENTION

U.S. Pat. No. 5,820,253 discloses a surgical lamp wherein a light source is mounted centrally in a lamp housing and the light rays are deflected by a parabolic reflector toward a light exit surface. The parabolic reflector surrounds the light source. The surgical lamp is attached to the ceiling of a treatment room via a ceiling arm system. The position of the lamp can be changed with the ceiling arm system in the horizontal as well as in the vertical directions. In operating rooms, an especially high clean room atmosphere must be present especially in the region of the surgical field which is irradiated by the surgical lamp. Normally, a laminar clean room gas flow is guided in the direction of the surgical field via gas channels which are located on the ceiling of the treatment room in the region of the surgical lamp.

With respect to the above, it is disadvantageous that the gas flow is partially deflected out of the vertical direction by the housing of the surgical lamp which causes eddy formations. The formation of eddy currents is especially disturbing when the position of the surgical lamp is changed during the medical intervention.

U.S. Pat. No. 3,923,482 discloses an arrangement which comprises a surgical lamp and a discharge device for germ-free air. However, the surgical lamp and the discharge device are attached as separate components to the ceiling stand. In a special embodiment, the individual lamps are arranged circularly about the discharge device so that the germ-free gas is introduced into the region of the primary light field; however, the focusing of the light is difficult because of the plurality of the lamps and the gas introduction is only possible at the center of the main light field of the lamps and at the periphery of the surrounding light field. The region lying therebetween, in which the lamps are located, does not allow for the passage of air. The introduction of air takes place via a delivery tube which opens laterally into the lamp housing and the lamp housing is attached to the ceiling by a separate holding bracket.

### SUMMARY OF THE INVENTION

It is an object of the invention to improve a surgical lamp of the kind described above so that a region, which extends over the entire light field of the surgical lamp, can be uniformly supplied with germ-free air without affecting the illumination of the treatment field.

The surgical lamp assembly of the invention includes: a lamp housing; a light source mounted in the housing for emitting light rays; the lamp housing having a lower end and defining a light exit surface; a concave reflector for deflecting the light rays toward the light exit surface; a ceiling arm system connected to the lamp housing and being movable to adjust the lamp housing both laterally and in elevation; a flow channel formed in the ceiling arm system and opening into the lamp housing; and, a gas moving device for moving gas through the flow channel and into the lamp housing so as to cause the gas to exit from the lower end.

The advantage of the invention is essentially that the inner cross section of the ceiling arm system is configured as a flow channel through which the germ-free air is conducted into the interior space of the surgical lamp. The air exits at the lower end of the surgical lamp via a plurality of gas exit openings arranged one adjacent the other. These gas exit openings are arranged in the region of the light exit area at a light permeable air-conducting plate. In this way, the entire light exit surface can be used as a radiating surface for the light as well as for guiding the gas flow out without thereby affecting the light intensity or the focusing of the light rays.

In a practical manner, the gas outlet openings are so arranged as discrete bores within the air-conducting plate that they extend mesh-like over the entire surface.

It is especially advantageous to configure the air-conducting plate as a grating or lattice. In this way, an especially large cross-sectional area for the air is realized within the air-conducting plate.

The lattice can be made of metal, plastic or glass. Air-conducting pieces of sheet metal can be present within the lattice in order to achieve a uniform exiting of the light with low turbulence. The cross section of the flow channel is so dimensioned that it has a cross-sectional area of at least 4 cm² at the narrowest location. With this cross section, no material flow noises develop. The air exit area in the region of the air-conducting plate is so dimensioned that the outflow velocity lies below 0.3 m per second. Usually, a velocity of 0.2 m per second is sought as it is present in comparable ventilating ceilings.

### BRIEF DESCRIPTION OF THE DRAWINGS

The invention will now be described with reference to the drawings wherein:

FIG. 1 is a side elevation view of a surgical lamp mounted on a ceiling arm system;

FIG. 2 is a section view of a carrier arm taken in the direction of line II-II of FIG. 1; and, FIG. 3 is a plan view of a light conducting plate as seen in the direction of arrow III of FIG. 1.

### DESCRIPTION OF THE PREFERRED EMBODIMENTS OF THE INVENTION

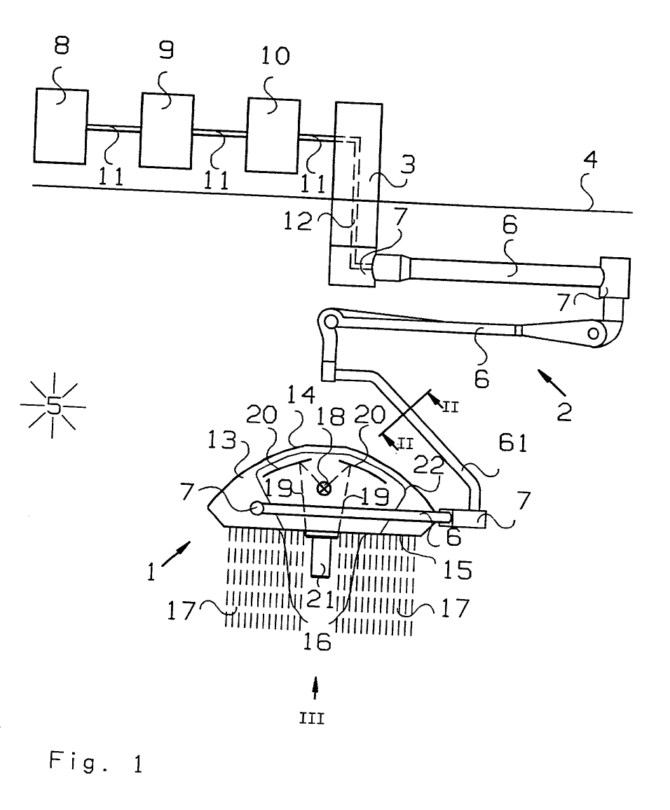

FIG. 1 shows a surgical lamp 1 which is attached to a ceiling 4 of a medical treatment room 5 via a ceiling arm system 2 and an attachment flange 3. The ceiling arm system 2 comprises individual carrier arms (6, 61) which are connected to each other by rotary joints 7. A gas delivery unit 8 for air is disposed above the ceiling 4 as are a bacteria filter 9 and a climate control apparatus 10 for equalizing temperature and imparting moisture to the inducted air. The air is conducted via conduits 11 into a flow channel 12 which extends from the attachment flange 3 to the surgical lamp 1. The flow channel extends centrally through the carrier arms (6, 61) and the rotary joints 7. The air flows from the flow channel 12 into the interior space 13 of the lamp housing 14 and the air exits via an air-conducting plate 15 at the lower end of the lamp housing 14. The air-conducting plate 15 comprises transparent material and is provided with a plurality of bores 16 lying one next to the other in the manner of a lattice. The air flows out through the bores 16 as a laminar parallel gas flow 17.

A light source 18 is disposed centrally within the illuminating housing 14. The light source 18 emits light rays 19 which are deflected by a concave reflector 20 to the air-conducting plate 15. To provide a better overview, the lamp housing 14 is shown as a section view taken along line 22.

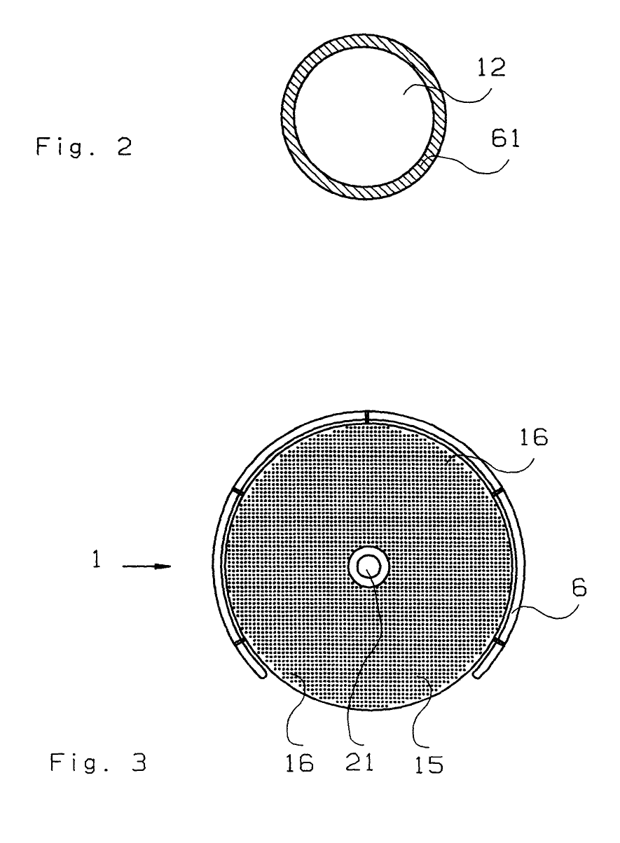

FIG. 2 shows a section view of the carrier arm 61 with the flow channel 12 at section line II-II of FIG. 1. The cross section of the flow channel 12 is so dimensioned that a cross-sectional area of at least 4 cm² is present at each location of the carrier arm (6, 61) and the rotary joints 7. A flow velocity is present here which is in the order of magnitude of below 2.5 m per second and causes flow noises which are hardly measurable.

FIG. 3 is a plan view of the air-conducting plate as seen in the direction of the arrow III of FIG. 1. The air-conducting plate 15 comprises transparent material and is provided with a plurality of bores 16 arranged in a lattice-like manner. The dimensioning of the air-conducting plate 15 is now considered in the context of an example with numbers.

For a type 700 lamp, the area of the air-conducting plate 15 without the central handle 21 is approximately 3,800 cm². The type 700 lamp is available from Drager Medical AG & Co. KGaA of Lubeck, Germany. With one bore 16 per cm² having a diameter of 1.5 mm, a total cross section of 66 cm² is available for the outflowing air with a total of 3,800 bores. The flow cross section at the air outlet is therefore greater by more than a factor of 10 than the flow cross section within the flow channel 12. In this way, the flow velocity reduces at the outflow side of the air-conducting plate 15 from 2.5 m per second in the flow channel 12 to a value in the order of magnitude of 0.2 m per second which lies in a range which is present in comparable ventilating ceilings.

It is understood that the foregoing description is that of the preferred embodiments of the invention and that various changes and modifications may be made thereto without departing from the spirit and scope of the invention as defined in the appended claims.

What is claimed is:

1. A surgical lamp assembly comprising:
a lamp housing;
a light source mounted in said housing for emitting light rays;
said lamp housing having a lower end and defining a light exit surface;
a concave reflector for deflecting said light rays toward said light exit surface;
a ceiling arm system connected to said lamp housing and being movable to adjust said lamp housing both laterally and in elevation;
a flow channel formed in said ceiling arm system and opening into said lamp housing; and,
a gas moving device for moving gas through said flow channel and into said lamp housing so as to cause said gas to exit from said lower end.

2. The surgical lamp assembly of claim 1, said lamp housing having an air-conducting plate at said lower end defining said light exit surface; and, said air-conducting plate having a plurality of bores formed therein for passing said gas out from said lamp housing.

3. A surgical lamp assembly comprising:
a lamp housing;
a light source mounted in said housing for emitting light rays;
said lamp housing having a lower end and a plate made of transparent material defining a light exit surface;
a concave reflector for deflecting said light rays toward said plate whereby said light rays pass from said light exit surface;
a ceiling arm system connected to said lamp housing and being movable to adjust said lamp housing both laterally and in elevation;
a flow channel formed in said ceiling arm system and opening into said lamp housing;
an air moving device for moving air through said flow channel and into said lamp housing and toward said plate; and,
said plate having a plurality of openings formed therein for conducting said air from said housing and toward a treatment area of a patient.

4. The surgical lamp assembly of claim 3, wherein said openings are a plurality of bores formed in said plate and distributed approximately uniformly over said plate thereby causing said air flow from said lamp housing toward said treatment area to be a laminar parallel air flow.
